(19) United States
(12) Patent Application Publication
(10) Pub. No.: US 2006/0232397 A1
(43) Pub. Date: Oct. 19, 2006

(54) Apparatus, system and method capable of very low power operation in a sensor network

(76) Inventor: Jasmeet Chhabra, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/107,652

(22) Filed: Apr. 14, 2005

(51) Int. Cl. G08B 1/08

(52) U.S. Cl. 340/539.3

(57) ABSTRACT

An embodiment of the present invention provides an apparatus, comprising a sensor node; the sensor node may be interfaced with a power save module (PSM) capable of decreasing the power consumption of the sensor node, wherein the power save module may include circuitry to accomplish the decrease in power consumption in the sensor node. The sensor node may further comprise a processor, radio modules, and additional application specific sensor and actuation modules. The processor, radio modules, and additional application specific sensor and actuation modules may be on either a single board or on separate boards communicating over a hardware interface. Further, the power save module may decrease the power consumption by incorporating a trigger circuit to wake up the sensor node and a cut off circuit to shut down the power to the sensor node. The power save module may further include a communication module to communicate with the sensor node, and interface lines to shut down and power up the power save module (PSM). The circuitry may implement in an extra 4-bit microcontroller. In operation when the sensor node needs to go into a sleep/shutdown mode it may switch on the PSM and send a message to the communication module of the PSM telling it when it needs to wake up and the PSM may then shut down the sensor node by cutting of the power to the node and starting a timer to keep track of when to wakeup the sensor node.

### BACKGROUND

In sensor networks and other wireless platforms, in large number of cases battery power may be the main power source. Due to the constraints of the limited life of batteries, researchers have put in a lot of effort in creating communication protocols to save power. These protocols typically tend to put the processor and radio in low power sleep modes. In a typical sensor network, where the communication is very infrequent, a sensor node processor spends most of its time in sleep mode. In such scenarios the power consumption is dominated by deep sleep mode power consumption.

Thus, a strong need exists for a system, apparatus and method capable of saving power in sensor network platforms in the deep sleep mode.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an architecture of a power saving module (PSM) of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

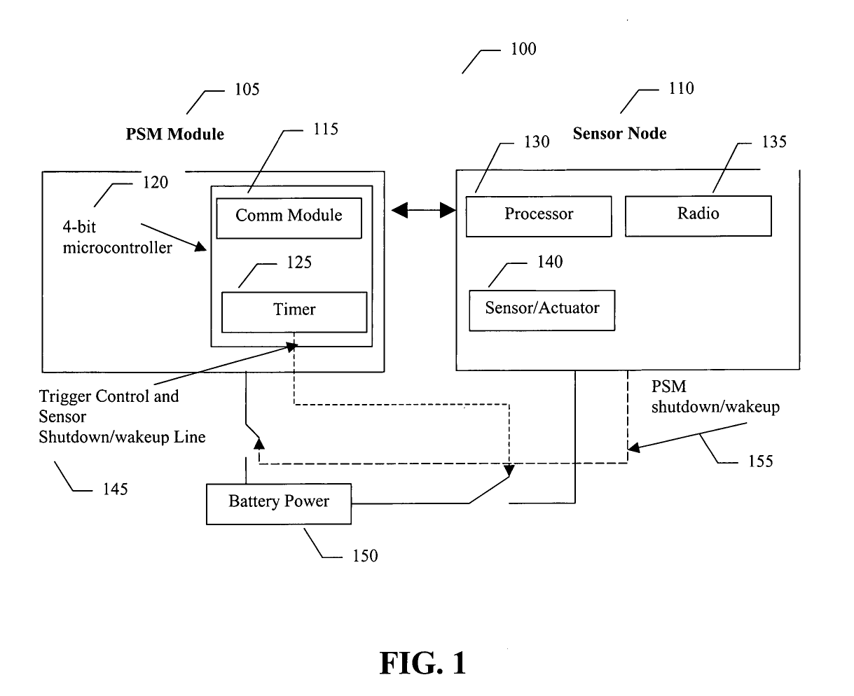

An embodiment of the present invention provides a system, apparatus and method capable of saving power in sensor network platforms in the deep sleep mode by using very low power additional circuitry to shut down the power to the processor and wake it up when needed. As illustrated in FIG. 1, shown generally as 100, an embodiment of the present invention may be implemented in an additional 4-bit microcontroller 120 that may extend the life time of a typical sensor node by up to 25 times, and even more if a specialized circuitry is used. It is understood that the present invention is not limited to a 4-bit microcontroller or any controllers in particular.

A typical sensor node 110 may have a processor 130 and radio modules 135, and additional application specific sensor and actuation modules 140; although the present invention is not limited in this respect. All of these may be either on a single board, or on separate boards communicating over some hardware interface. An embodiment of the present invention may provide the addition of a power save module (PSM) 105 to the sensor board. The power save module 105 may have, although is not required to have, circuitry to provide following functions:
a.) A trigger circuit (not shown, but known to those of ordinary skill in the art) to wake up the sensor node 110;
b.) A cut off circuit (not shown, but known to those of ordinary skill in the art) to shut down the power (power illustrated by battery power 150) to the sensor node 110;
c.) A communication module 115 to communicate with the sensor node 110;
d.) A timer 125 to keep track of time to wake up the sensor node 110; and
e) Interface lines 145 to shut down and power up the power save module (PSM).

In an embodiment of the present invention, all of the above circuitry may be implemented in an extra 4-bit microcontroller, but additional circuitry specially designed to provide the above mentioned functionality may be used to save extra power.

In an embodiment of the present invention, when the sensor node 110 needs to go to sleep/shutdown mode, it may:
a.) Switch on the PSM 105; and
b.) Send a message to the communication module 115 of the PSM 105 telling it when it needs to wake up.

The PSM 105 may then:
a.) Shut down 155 the sensor node 110 by cutting of the power to the node; and
b.) Start a timer 125 to keep track of when to wakeup 155 the sensor node 110.

After the timer expires, the PSM 105 may power up the sensor node 110. When the sensor node 110 wakes up, it may shut down the PSM 105 to save additional power. Thus, in the power save mode only, the PSM 105, which is a very low power circuit, remains on, thereby saving a significant amount of power.

In an embodiment of the present invention, the PSM may use a 4-bit microcontroller to implement all the functionality of a PSM—but again, any low power controller may be used. A typical ultra-low power 4-bit microcontroller consumes 1.8 μA at 1.5 v (i.e.
2.7 μwatts) in active mode, while a typical processor used in a low power sensor module may consume up to
75 μwatts in its deepest sleep mode using an internal watchdog for wakeup. Thus, if the 4-bit microcontroller is used to keep track of sleep wakeup times rather then the internal watchdog timer in a processor, it is possible to save up to 25 times more power in the sleep mode for a sensor node. Since, over long periods of time with sparse communication patterns the sleep mode power consumption typically dominates the power consumption in a sensor node, the present invention may save significant amount of power. The base lifetime of a sensor node (lifetime of a node if it spent all its time in sleep mode) may be increased from 1 year up to 25 years by use of an embodiment of the present invention. In sensor networks where low cost is a requirement and changing batteries is expensive, this proves to be very useful in installing long lasting networks.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. An apparatus, comprising:
a sensor node, said sensor node interfaced with a power save module (PSM) capable of decreasing the power consumption of said sensor node.

2. The apparatus of claim 1, wherein said power save module includes circuitry to accomplish said decrease in power consumption in said sensor node.

3. The apparatus of claim 1, wherein said sensor node comprises a processor, radio modules, and additional application specific sensor and actuation modules.

4. The apparatus of claim 3, wherein said processor, radio modules, and additional application specific sensor and actuation modules are one either a single board or on separate boards communicating over a hardware interface.

5. The apparatus of claim 1, wherein said power save module decreases the power consumption by incorporating a trigger circuit to wake up said sensor node.

6. The apparatus of claim 1, wherein said power save module decreases the power consumption by incorporating a cut off circuit to shut down the power to the sensor node.

7. The apparatus of claim 1, wherein said power save module includes a communication module to communicate with the sensor node.

8. The apparatus of claim 1, wherein said power save module includes a timer to keep track of time to wake up said sensor node.

9. The apparatus of claim 1, wherein said power save module includes interface lines to shut down and power up said power save module (PSM).

10. The apparatus of claim 2, wherein said circuitry is implemented in an extra 4-bit microcontroller.

11. The apparatus of claim 2, wherein said circuitry is specially designed.

12. The apparatus of claim 1, wherein when said sensor node needs to go into a sleep/shutdown mode it switches on the PSM and sends a message to the communication module of the PSM telling it when it needs to wake up and said PSM then shuts down said sensor node by cutting of the power to the node and starts a timer to keep track of when to wakeup the sensor node.

13. The apparatus of claim 12, wherein after said timer expires, said PSM powers up said sensor node and when said sensor node wakes up it shuts down the PSM to save additional power.

14. A method of decreasing the power consumption of a sensor node comprising interfacing a power save module (PSM) with said sensor node, said PSM capable of decreasing the power consumption.

15. The method of claim 14, further comprising including circuitry said power save module to accomplish said decrease in power consumption in said sensor node.

16. The method of claim 14, further comprising incorporating into said sensor node a processor, radio modules, and additional application specific sensor and actuation modules.

17. The method of claim 14, further comprising incorporating a trigger circuit into said PSM to wake up said sensor node.

18. The method of claim 14, further comprising incorporating a cut off circuit to shut down the power to the sensor node into said PSM.

19. The method of claim 14, further comprising keeping track of time to wake up said sensor node by including a timer in said power save module.

20. The method of claim 15, further comprising implementing said circuitry in an extra 4-bit microcontroller.

21. The method of claim 14, further comprising switching on the PSM when said sensor node needs to go into a sleep/shutdown mode it and sending a message to the communication module of the PSM telling it when it needs to wake up and said PSM then shutting down said sensor node by cutting of the power to the node and starting a timer to keep track of when to wakeup the sensor node.

22. An article, comprising:
a storage medium having stored thereon instructions, that, when executed by a computing platform results in:
decreasing the power consumption of a sensor node by controlling a power save module interfaced with said sensor node, wherein said power save module includes circuitry to accomplish said decrease in power consumption in said sensor node.

23. The article of claim 22, wherein said power save module decreases the power consumption by incorporating a trigger circuit to wake up said sensor node and a cut off circuit to shut down the power to the sensor node.

24. A monitoring system, comprising:
at least one a sensor node, said sensor node interfaced with a power save module (PSM) capable of decreasing the power consumption of said sensor node.

25. The monitoring system of claim 24, wherein said power save module includes circuitry to accomplish said decrease in power consumption in said sensor node and said sensor node further comprises a processor, radio modules, and additional application specific sensor and actuation modules.

26. The monitoring system of claim 25, wherein said power save module decreases the power consumption by incorporating a trigger circuit to wake up said sensor node and a cut off circuit to shut down the power to the sensor node.
